(19) United States
(12) Patent Application Publication
(10) Pub. No.: US 2009/0134797 A1
(43) Pub. Date: May 28, 2009

(54) Current Lead-Through for Ceramic Burner in Halogen-Metal Vapor Discharge Lamps

(75) Inventor: Bernd Spaniol, Hammersbach (DE)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: W.C. Heraeus GmbH, Hanau (DE)

(21) Appl. No.: 12/237,101

(22) Filed: Sep. 24, 2008

(30) Foreign Application Priority Data
Sep. 28, 2007 (DE) 102007046899.9-54

(51) Int. Cl. H01J 61/18; H01J 61/02; H01J 9/28

(52) U.S. Cl. 313/626; 313/638; 445/1; 445/58

(57) ABSTRACT

In a halogen-metal vapor lamp having a ceramic housing (2) and a current lead-through conductor (3) arranged in the ceramic housing, the glazed part of the current lead-through conductor (3) is a niobium alloy doped with phosphorus, in particular with 50 ppm to 0.5 wt. % phosphorus. The glazed part of the current lead-through conductor (3) preferably has inside the ceramic vessel (2) a shielding (4) from halides, which is connected to a tungsten electrode. The glazed part of a current lead-through conductor (3) in the form of a pin having a length of 5 to 30 mm and a diameter of 0.2 to 2 mm is a niobium alloy doped with phosphorus. For the glazing of current lead-through conductors in a ceramic burner, a current lead-through conductor made of a niobium alloy temperature-stabilized with phosphorus is glazed. For the production of halogen-metal vapor lamps having a ceramic housing (2) and a current lead-through conductor (3) arranged in the ceramic housing (2), the current lead-through conductor (3) is exposed to heat treatments at temperatures of at least 1000° C. and there does not soften so much that it bends.

### BACKGROUND OF THE INVENTION

The present invention relates to a current lead-through conductor through a ceramic burner in halogen-metal vapor lamps.

During the production of the electrode system and its glazing in the ceramic housing, heat treatment processes are necessary, which soften the niobium-based current lead-through conductor pins. The niobium-zirconium-1 alloy used for this purpose softens during production. This leads to rejects in the production, because the pins might become bent, or to increased expense during production in order to minimize rejects.

European Patent EP 1 571 228 B1 describes a high temperature-resistant niobium wire, which is enriched with phosphorus. The niobium is doped during the electron-beam fusing or electric-arc fusing process or during the sinter block production from niobium powder by the addition of phosphorus or phosphorus-containing pre-alloys. The phosphorus-containing alloy can be worked at room temperature into wire with diameters of 0.15 to 0.4 mm. The material still does not exhibit massive coarse grain formation and does not become brittle up to 1600° C. This is especially advantageous for the use of tantalum capacitors.

German Patent DE 10 2005 038 551 B3 describes a frame or a high temperature-resistant wire for one-sided socket lamps based on niobium, which is enriched with phosphorus. The wire has a permanent elongation limit Rp 0.2 of at least 200 MPa or a tensile strength Rm of at least 300 MPa.

U.S. Pat. No. 4,694,219 describes an arc discharge lamp, in which a tube made of PCA, sapphire, or spinel, is sealed at its end against a cermet made of tungsten and aluminum oxide with a mixture based on SiO₂, MgO, and Al₂O₃ with other additives, for example 2 to 5 percent phosphorous pentoxide. U.S. patent application publication No. 2005/0200281 discloses a discharge lamp with a ceramic discharge vessel and two current lead-through conductors. Different alternatives are described for the current lead-through conductors based on niobium or molybdenum film or molybdenum-aluminum oxide-cermet.

### BRIEF SUMMARY OF THE INVENTION

The object of the present invention comprises providing a current lead-through conductor through a ceramic burner, which is more easily workable than NbZr1 pins; in particular a current lead-through conductor, which does not soften so much under heat treatment processes that the pins bend.

To achieve the object, current lead-through conductors are provided for glazing in the ceramic burner, in particular current lead-through conductor pins made of a niobium alloy, which has been temperature-stabilized by phosphorus doping.

Phosphorus dopings in the range of 100 μg/g (ppm) to 2000 μg/g (ppm), in particular of 300 μg/g to 700 μg/g have proven effective. Preferably, the current lead-through conductor is protected from halides. For this purpose, it has proven effective to protect the current lead-through conductor on the inside of the burner housing with a molybdenum winding or a cermet as shielding from the halides.

In the production of metal vapor lamps, welding and annealing processes are typical, for example, for reasons of purification or for reducing stress. The current lead-through conductors according to the invention made of niobium doped with phosphorus no longer bend during the heat treatments.

Preferably, the current lead-through conductor is installed as a pin in the burner housing. Pins having a length of 5 to 30 mm, in particular of 10 to 20 mm, and a diameter of 0.2 to 2 mm, in particular 0.5 to 1.0 mm, have proven effective. For production of pins, wires are drawn from a phosphorus-doped alloy and cut into pins, in particular cut to length. Proven alloys are described in EP 1 571 228 B1 and DE 10 2005 038 551 B3. The pins according to the invention are suitable especially for housings made of aluminum oxide.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a longitudinal sectional view through a burner housing;

FIG. 2 is a graphical representation of the mechanical properties of a wire according to an embodiment of the invention; and

FIG. 3 is a graphical representation showing corresponding mechanical properties of a NbZr1 wire known from the prior art.

### DETAILED DESCRIPTION OF THE INVENTION

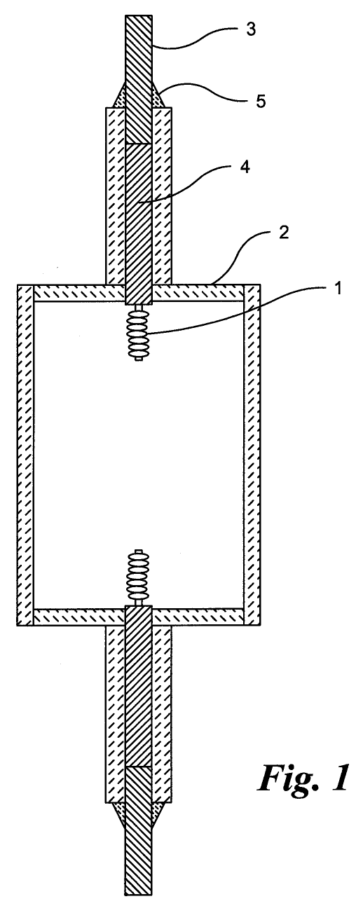

FIG. 1 shows a burner housing 2 made of PCA (polycrystalline alumina). Inside the burner housing 2 tungsten electrodes 1 are arranged, which are each fused to a molybdenum coil 4 or MoAl₂O₃ cermet 4. The molybdenum coil 4 or MoAl₂O₃ cermet 4 contacts the inner wall with a positive fit in a tubular part of the burner housing 2 and protects the current lead-through conductor 3 from the halides in the burner housing 2. The current lead-through conductor 3 is soldered with a glass solder 5 into the burner housing 2 and is connected outside of the burner with a power lead or a rack.

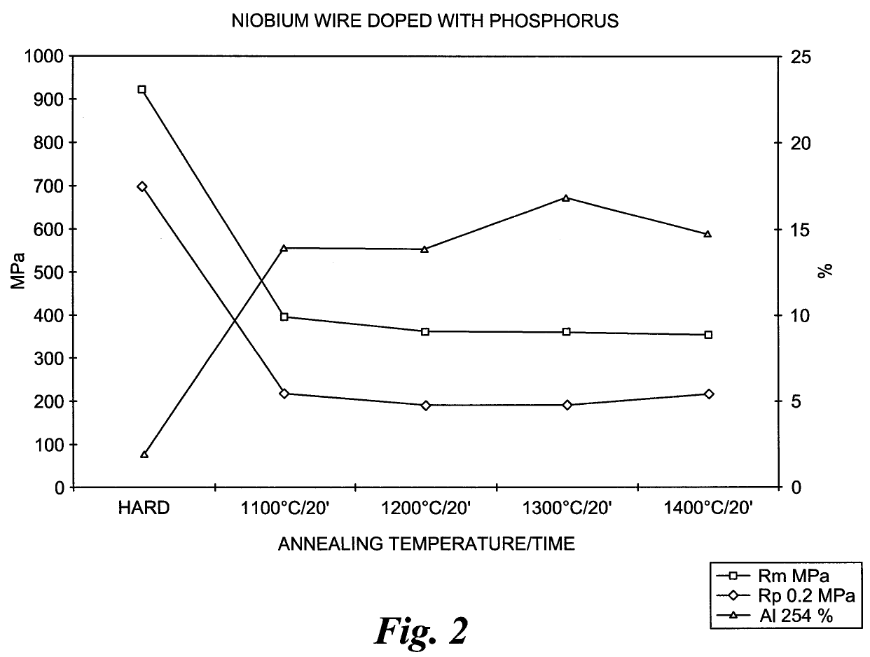

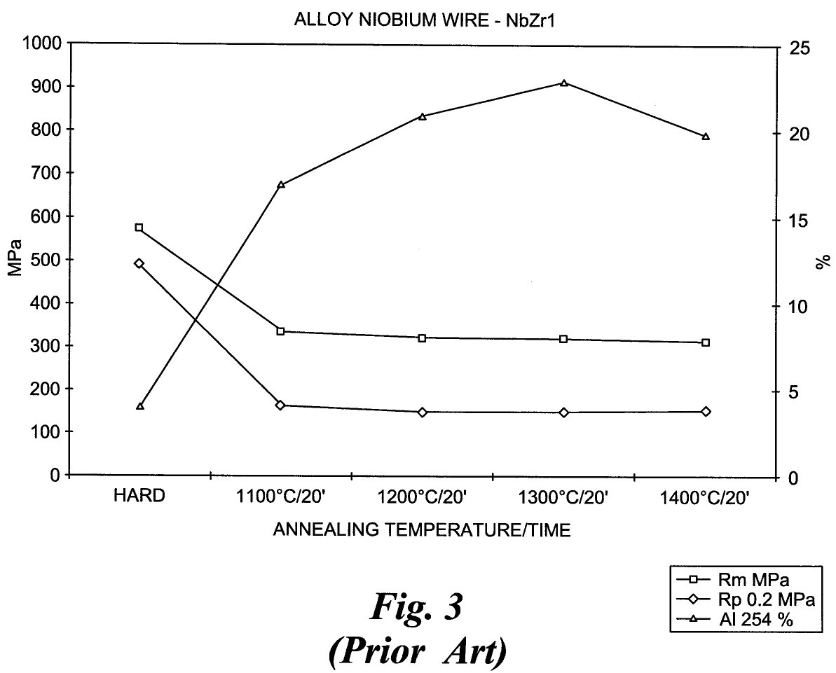

FIG. 2 shows the effect of heat on the mechanical properties of a 0.4 mm thick niobium wire doped with phosphorus. The softening of this niobium wire doped with phosphorus, especially the lowering of the apparent yielding point (Rp 0.2) in a temperature range of 100° C. to 1400° C., as is typical in joining operations and annealing processes for the production of electrode systems for metal halide lamps, occurs at approximately 50 MPa less than for 1% alloyed niobium wire (FIG. 3). The determined values are dependent on diameter. Thicker wires soften somewhat less in the elapsed time period of 20 minutes. The comparability is realized through the selection of the same diameter for the wire doped with phosphorus and the standard alloy NbZr1. The apparent yielding point is the technically relevant measure from when permanent deformation of the components occurs.

According to the invention, a wire doped with phosphorus could be achieved with 25% higher stability compared to the niobium standard alloy NbZr1. These improved mechanical properties under the effect of heat allow better handling and minimize the risk of mechanical bending of the pins during the production of the electrode systems.

1-10. (canceled)

11. A halogen-metal vapor lamp comprising a ceramic housing (2) and a current lead-through conductor (3) arranged in the ceramic housing, the current lead-through conductor having a glazed part, wherein the glazed part of the current lead-through conductor (3) is a niobium alloy doped with phosphorus.

12. The halogen-metal vapor lamp according to claim 11, wherein the niobium phosphorus alloy contains 50 ppm to 0.5 wt. % phosphorus.

13. The halogen-metal vapor lamp according to claim 11, wherein the niobium alloy contains 0.1 to 2 wt. % zirconium.

14. The halogen-metal vapor lamp according to claim 11, wherein the glazed part of the current lead-through conductor (3) inside the ceramic housing (2) has shielding (4) against halides and is connected to a tungsten electrode.

15. The halogen-metal vapor lamp according to claim 14, wherein the shielding (4) is a molybdenum coil or cermet.

16. The halogen-metal vapor lamp according to claim 11, wherein the glazed part of the current lead-through conductor (3) has a form of a pin having a length of 5 to 30 mm and a diameter of 0.2 to 2 mm.

17. The halogen-metal vapor lamp according to claim 11, wherein the alloy contains 50 ppm to 5 wt. % phosphorus, 0.1 to 2 wt. % zirconium, and the remainder niobium having a purity of 99.8%.

18. A method for production of a halogen-metal vapor lamp having a ceramic housing (2) and a current lead-through conductor (3) arranged in the ceramic housing (2) and comprising a niobium alloy, the method comprising temperature-stabilizing the current lead-through conductor by incorporating phosphorus in the niobium alloy and exposing the current lead-through conductor (3) to heat treatment at a temperature of at least 1000° C., such that the current lead-through conductor does not soften to the extent that it bends.

19. The method according to claim 18, wherein the heat treatment comprises welding or annealing the current lead-through conductor.

20. The method according to claim 18, further comprising forming a part of the current lead-through conductor into a pin and glazing the pin.

21. The method according to claim 18, further comprising protecting the current lead-through conductor from halides inside the housing.

22. The method according to claim 21, wherein the current lead-through conductor is protected with a shielding comprising a molybdenum coil or cermet.
